(19) United States
(12) Patent Application Publication
(10) Pub. No.: US 2001/0033915 A1
(43) Pub. Date: Oct. 25, 2001

(54) Optical data storage disc protector

(76) Inventors: Ryan Joseph Ehmann, Sula, MT (US); Shawn Russell Alstad, Phoenix, AZ (US)

Correspondence Address: Shawn Alstad, 7611 South 36th Street #211, Phoenix, AZ, 85040, US

(21) Appl. No.: 09/768,106

(22) Filed: Jan. 23, 2001

Related U.S. Application Data
(60) Provisional application No. 60/177,617, filed on Jan. 24, 2000.

(51) Int. Cl. B32B 3/00

(52) U.S. Cl. 428/195

(57) ABSTRACT

A thin, flexible polymer used as an optical data storage disc protector capable of adhering by its static cling material properties to protect a compact disc during handling and storage while consuming minimal space. The outside Diameter (12) of the Protector (10) is larger than the outside diameter (17) of the compact disc (20), which allows for easy handling, application, and removal of the protector (10) repeatedly onto and off of a compact disc (20). Graphics 22 may be printed onto the outside surface (15) of the protector (10) for identifying the disc (20). Harmful sunlight to the compact disc (20) may be decreased or eliminated by an impregnated Ultraviolet protection layer (19).

### CROSS-REFERENCE TO RELATED APPLICATIONS

This application is entitled to the benefit of Provisional Patent Application Ser. No. 60/177,617 filed Jan 24, 2000.

### BACKGROUND

1. Field of Invention

This invention relates to a compact disc protector, and more particularly, pertains to a compact disc protector, which is thin, re-usable, ultraviolet resistant, and print capable.

2. Description of Prior Art

Compact discs and digital videodiscs are becoming the most acceptable method to transport information. They are used to hold music, data or computer software. They have become the standard medium for distributing large quantities of information in a reliable package. Do to the immense and immediate transition into today's communication revolution; it has forced the imperative issue to store more data into a more compact storage device. Optical data storage discs provide the capability to store enormous amounts of this useful information. However, it is critical to protect these investments to ensure the data remains useful and in an uncorrupted form to provide years of service.

Originally, these storage devices, namely music compact discs, were shipped with a plastic protective case. These cases served the purpose of protecting the compact disc while it is in its case. However, with the exponentially growing rate at which information is recorded, duplicated, and transported, consumers found themselves buying, trading, or owning numerous compact discs with lost or damaged original protective cases, or compact discs that did not come with a protective case, re-writable compact discs for example.

Thereafter, inventors created several types of compact disc protectors to provide the consumer an aftermarket method of data disc protection. U.S. Pat. No. 4,879,710 to Iijima (1989) discloses a data storage protector that uses an adhesive to adhere to these discs. These protectors are both expensive and may only be re-used a few times. U.S. Pat. No. 4,983,437 to Merrick (1991) used an adhesive decal to fully adhere to the top surface of a compact disc. It permanently attaches to a compact disc or digital videodisc not demonstrating a method of removal it if it becomes damaged. Consumers objected to both of these ideas because they felt the compact discs should not need protection when it is in the compact disc player. Others were concerned that these protective devices could possibly damage the equipment if they were to fail. These storage devices may also inadvertently obtain other contaminants, such as water condensation, dust, dirt or grease, only to be placed inside the expensive equipment possibly causing harm to the equipment or the compact disc.

The main structure of a compact disc consists of an injection-molded piece of clear polycarbonate plastic measuring 1.2 millimeters thick. During manufacturing, this plastic is impressed with microscopic bumps, which are arranged as a single, continuous, extremely long spiral track of data. The distance between these spiral tracks is 1.6 microns and the width of the bumps are 5 microns. The elongated bumps that make up the track are each 0.5 microns wide, a minimum of 0.83 microns long and 0.125 microns high. Once the clear piece of polycarbonate is formed, a thin, reflective aluminum layer is applied onto the disc, covering the bumps. This layer is 0.125 microns high. A thin acrylic layer is then sprayed over the aluminum to protect it. The label is then printed onto the acrylic. A compact disc thus contains a single spiral track of data, circling from the inside of the disc to the outside. Very minimal effort is required to damage one of these storage devices.

The fundamental job of the compact disc player is to focus the laser on the track of bumps. The laser beam passes through the polycarbonate layer, reflects off the aluminum layer and hits an optical-electronic device that detects changes in light. The bumps reflect light differently than the “lands” (the rest of the aluminum layer), and the optical-electronic sensor detects that change in reflectivity. The electronics in the drive interpret the changes in reflectivity in order to read the bits that make up the bytes. This information is then interpreted via the electronic circuitry and is presented in the form of music, television, or computer data.

Static cling vinyl is a special formulation of polyvinyl chloride (PVC) to which a large amount of plasticizer (liquid) has been added. This highly plasticized formulation is exceptionally pliable. The vinyl is calendared to give it a smooth finish. When the vinyl film is applied to a smooth, glossy surface, it adheres firmly without the need for an adhesive. Because there is no adhesive, application or installation is very easy. It may be removed and re-applied nearly indefinitely. The plasticizer that makes the vinyl pliable enough to adhere is a liquid that remains a liquid in the vinyl.

Static cling vinyl (SCV) is so flexible that when it is removed from the release liner and applied to a smooth, glossy surface such as glass, smooth acrylics, gloss surfaced metals or similar surfaces and smoothed down, it essentially becomes a flat suction cup. This occurs because a low-pressure zone is created between the SCV and the bottom of the polycarbonate layer of the CD when the two are lightly pressed together. The flexibility of the SCV provides a temporary seal in these areas of contact because the air between the two has been removed. The outside atmospheric pressure, at sea level for example, is 14.7 pounds per square inch (PSI) or 101.3 kilopascals (kpa). This normal atmospheric pressure in conjunction with the low-pressure zone created allows the atmospheric pressure to continually press together the SCV and the bottom polycarbonate layer of the compact disc. Thus it adheres to the surface without any adhesive whatsoever. The term “static cling” is a misnomer. While the vinyl may form an extremely small static electric charge when it is peeled from the surface where it was applied, static electricity plays no part in the vinyl's ability to adhere to suitable surfaces. That's why static cling vinyl will adhere equally well at almost any relative humidity level.

When the vinyl is first laminated to the liner, the surface energy of the vinyl is about 32-34 Dynes/cm2. Even though the initial surface energy of static cling vinyl is relatively low, it may be readily and reliably printed using conventional (solvent) screen-printing, ultraviolet screen-printing and ultraviolet offset printing methods. For conventional offset and flexographic printing, a print receptive top coating is usually desirable. Flexographic printers sometimes accomplish this by applying a primer at the first print station. This may provide excellent results but does tie up a print station that might otherwise be used for the job. The best solution is a print receptive top coating applied to the static cling vinyl that is designed specifically for the printing method to be used. The top coating not only provides a higher surface energy, it may also speed ink drying so the press may be run faster for improved productivity. Other methods of printing include: thermal transfer printing; electrostatic printing; and ink jet printing.

Polyvinyl Chloride (PVC) is a thermoplastic that is a polymer of vinyl chloride. By plasticization, hard PVC resins may be made into flexible, elastic plastic. A plastic is any synthetic organic material that may be molded under heat and pressure into a shape that is retained after the heat and pressures are removed. Thermoplastics may be repeatedly softened and reshaped by heat and pressure. Plastics are made up chiefly of a binder consisting of long chainlike molecules called polymers. Binders may be natural or synthetic materials. Thermoplastics may be reshaped because their linear or branched polymers may slide past one another when heat and pressure are applied. Adding plasticizer and fillers to the binder improves a wide range of properties such as, hardness, elasticity, and resistance to heat, cold, acid or ultraviolet rays. Polyvinyl film may block up to 80% to 90% of the sun's damaging ultraviolet rays, simply by the formula in the plasticizer. Adding pigments imparts color. Plastic products are commonly made from plastic powders. In compression molding, heat and pressure are applied directly to the powder in the mold cavity. Alternatively, the powder may be plasticized by outside heating and then poured into molds to harden by a process called transfer molding; be dissolved in a heating chamber and then forced by a plunger into cold molds to set which is called injection molding; or be extruded through a die in continuous form to be cut into lengths known as extrusion molding.

### SUMMARY OF THE INVENTION

The present invention has a general purpose of protecting compact discs. It is thin, flexible, and may be re-used nearly an infinite number of times. It prevents fingerprints and other substances or foreign particles from contacting the data side of a compact disc, thus making handling simple. This protector may also be used with many other products. It is a means of protecting optical data storage devices either out of or inside their original cases. It is made from static cling material and thus allows it to be used repeatedly without wearing out.

This SCV disc may be manufactured in many ways. They may be punched out of a sheet of this vinyl material using a punch and die means of manufacture, or they may be injected into a mold cavity.

### OBJECTS AND ADVANTAGES

Accordingly, besides the objects and advantages of the flexible protectors described in the above patent, several objects and advantages of the present invention are:

(a) To provide a protector which may be re-used repeatedly without wearing out or losing it's ability to electrically attract the surface of the compact disc;

(b) To provide a protector that may be used with a substantial amount of cases without damaging or interfering with: The compact disc, the compact disc protector, or the compact disc case;

(c) To provide a protector produced in a variety of colors, slogans, and advertisements;

(d) To provide a protector which is both flexible and may be brightly colored with advertisements;

(e) To provide a protector which will present a superior surface for the reception of labeling or print;

(f) To provide a protector which assists in identifying a particular compact disc by being clear, opaque, multi-colored, or contain printed images, or text using any convention means of printing.

(g) To provide a protector whose labeling may not be altered; and

(h) To provide a protector which will not be slippery when handled with wet or greasy fingers.

Further objects and advantages are to provide a compact disc protector, which may be easily and conveniently used without tools. It may be removed and reapplied repeatedly without ever damaging the compact disc or the protector. It is ultraviolet resistant. It is inexpensive to manufacture, lightweight and compact. It is durable and in the event that the protector is to become scratched, it may still be used without effecting the safety or quality of the compact disc. Printed graphics allow for advertisement and make it easy to find, versus a clear protector that could be easily lost. It may come in an assortment of colors and lettering schemes, which would allow the consumer an easier way to determine which optical data storage disc is being searched for. Without this product, an optical data storage device has text on only one side. Hence, if it is placed with the data read side up, it may not easily be determined which data storage device it underlying unless it is raised up and rotated 180 degrees to any axis parallel to the surface in which it rested. With this invention, it would provide an additional method for determining the optical data storage disc by the identifying graphics printed on the protector. Another alternative is that when the protector is applied, it allows the compact disc to be placed read side down thus allowing one to observe the graphics or text originally printed onto a compact disc label. Still further objects and advantages will become apparent from a consideration of the ensuing description and drawings.

### BRIEF DESCRIPTION OF THE DRAWINGS

FIG. 1 illustrates a plan view of a disc protector, according to the present invention, and a compact disc.

FIG. 2 illustrates a broken section view taken through line 2-2 of FIG. 1.

FIG. 3 illustrates the application of the disc protector of FIG. 1 to a compact disc.

### REFERENCE NUMERALS IN DRAWINGS

10. Protector

11. Inside Diameter of Protector

12. Outside Diameter of Protector

13. Contact Surface of Protector

14. Axis

15. Outside Surface of Protector

16. Inside Diameter of Compact Disc

17. Outside Diameter of Compact Disc

18. Surface of Compact Disc (Read Side)

19. Ultraviolet impregnated layer

20. Compact Disc

21. Hand

22. Graphics

23. Surface of compact disc (non-read)

### DETAILED DESCRIPTION OF THE PREFERRED EMBODIMENT

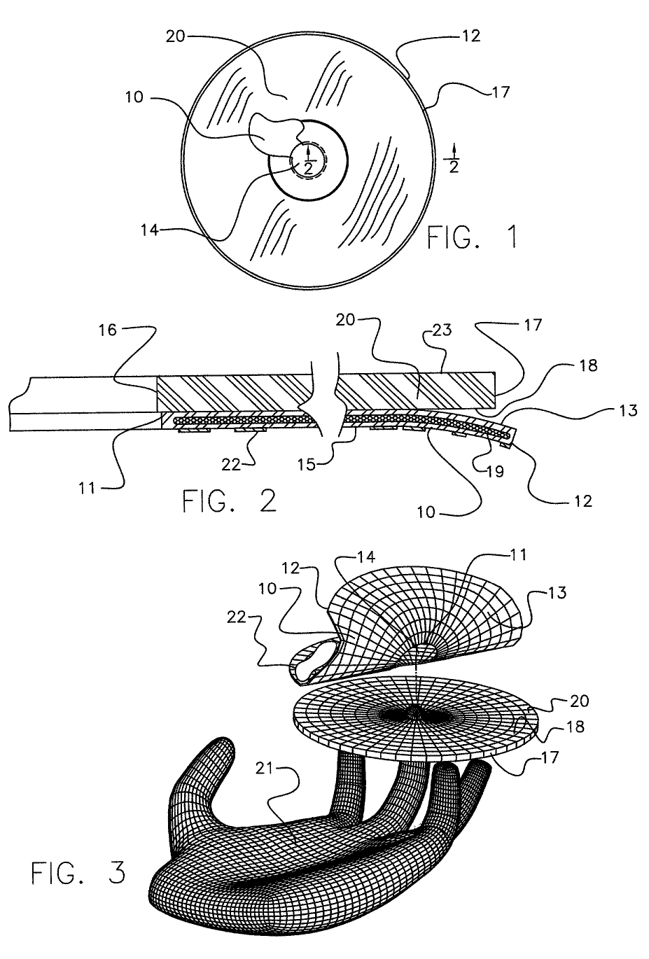

A preferred embodiment of the closure of the present invention is illustrated in FIG. 1. (plan view) and FIG. 2. (section view). The protector has a thin base 10 of uniform cross section consisting of a flexible sheet of material, which may be repeatedly bent and straightened out without fracturing. The protector 10 has an outside diameter (approximately 120.6 millimeters or 4.75 inches) 12 that is coaxial 14 with the protector 10 inside diameter 11 (approximately 15.9 millimeters or 0.625 inches). The inside surface 13 of the protector 10 will statically cling to the read side 18 of the compact disc 20. The inside diameter 11 of the protector 10, the outside diameter 12 of the protector 10, the inside diameter 16 of the compact disc 20 and the outside diameter 17 of the compact disc 20 should be positioned as to permit them to be located coaxially 14. The inside Diameter 11 of the protector 10 is slightly larger than the inside diameter 16 of the compact disc 20. Thus, allowing the protector 10 to be placed face down 15 into any type of case followed by placing the read side 18 of the compact disc 18 into the same case, which aids in the application, but not required as depicted in FIG. 3. The outside diameter 12 of the protector 10 is slightly larger than the outside diameter 17 of the compact disc 20. This allows the user 21 to place a finger through the inside diameter 16 of the compact disc 20 and pull the surface 13 of the protector 10 away from the opposing surface 18 of the compact disc 20 at any location circumferentially between the outside diameter 12 of the protector 10 and the outside diameter 17 of the compact disc 20.

Graphics 22 may be printed onto the outside surface 15 of the protector 10 for identifying the disc 20 that is face down 23.

The material from which the protector 10 is made need not be scratch resistant. It must only be durable to a slight tensile load. FIG. 2 portrays an impregnated Ultraviolet protection layer 19.

The thickness of this invention measures between 0.005 inches and 0.008 inches or approximately 0.150 millimeters.

### OPERATION—FIG. 3

A preferred method of application is depicted in FIG. 3 (isometric view). The user 21 holds the compact disc 20 by inserting a finger through the inside diameter 16. Using the other hand, one may hold onto the protector 10 with a thumb and index finger on surfaces 14 and 13 respectively. By gently allowing surface 13 to contact surface 18 close to the diameter at 17, the protector 10 may be adjusted for coaxially 14 by using the finger through the inside diameter 16 as a guide to locate the inside diameter 11 of the protector 10.

A method of removal for the protector 10 is for the user 21 to place a finger through the inside diameter 16 of the compact disc 20 and pull the surface 13 of the protector 10 away from the opposing surface 18 of the compact disc 20 at any location circumferentially between the outside diameter 12 of the protector 10 and the outside diameter 17 of the compact disc 20.

### ADVANTAGES

From the description above, a number of advantages of this optical data storage disc protector become evident:

(a) Prevents fingerprints and other substances or foreign particles from contacting the data side of a compact disc.

(b) Numerous application methods, FIG. 3 demonstrates only one example.

(c) The protector may function as a compact disc case, consuming minimal amounts of space.

(d) The protector may be applied to the compact disc quite carelessly without causing any harm.

(e) The protector's outside diameter is larger than that of a compact disc, making it easy to handle.

(f) The protector's inside diameter is larger than that of a compact disc, preventing interferences when applying directly into a case or via hand.

(g) The protector saves time, money and data.

### CONCLUSION, RAMIFICATIONS, AND SCOPE

Accordingly, the reader will see that the optical data storage disc protector of this invention may be used to protect a compact disc easily and conventionally, may be removed just as easily and without damage to the compact disc, and may be reused without requiring a new protector. It also requires no additional tools for installation.

It permits compact discs to be stacked on top of each other without damaging them, thus requiring a substantial less amount of space than conventional cases;

It permits a unique and simple method of protecting a compact disc, either in or out of the case;

It allows a user extreme flexibility while handling a compact disc;

It permits a protector made from a material that does not contain adhesives and will not omit or discard any form of residue;

It permits a protector that does not require a peel-away backing to access any type of adhesive;

It will not yield in bending, torsion, or compression;

It permits a protector that is ultraviolet resistant, thus helping protect the compact disc from harmful sunlight;

It permits a protector which may be re-used repeatedly without wearing out or losing it's ability to electrically attract the surface of the compact disc;

It permits a protector produced in a variety of colors, slogans, and advertisements to aid in locating a particular upside down compact disc not contained in a case;

It permits a protector which will present a superior surface for the reception of labeling or print;

It permits a protector, which may be clear, opaque, multi-colored, or contain printed images, or text using any convention means of printing;

It permits a protector whose labeling may not be altered; and

It permits a protector, which will not be slippery when handled with wet or greasy fingers.

Although the description above contains much specificity, these should not be construed as limiting the scope of the invention but as merely providing illustrations of some of the presently preferred embodiments of this invention. For example, the protector may have different sizes and shapes. It may be used to protect mini-discs, which are much smaller or even LP's, which are much larger. It may be made triangular, rectangular, square, star shaped, or any irregular shape thereof that may or may not extend the boundaries of the optical data storage disc it is to protect.

Thus the scope of the invention should be determined by the appended claims and their legal equivalents, rather than by the examples given.

I claim:

1. Compact disc protector for protecting a bottom surface of a compact disc comprising.
(a) a static cling polymer film of predetermined size containing an aperture,
(b) information or graphics printed onto said polymer film for identification, and
(c) ultraviolet protection impregnated into said polymer film, whereby said protector will fit securely to said surface.
